(19) United States
(12) Patent Application Publication
(10) Pub. No.: US 2004/0106312 A1
(43) Pub. Date: Jun. 3, 2004

(54) Socket

(75) Inventor: Shosuke Adachi, Nagoya (JP)

Correspondence Address: BACON & THOMAS, PLLC, 625 SLATERS LANE, FOURTH FLOOR, ALEXANDRIA, VA, 22314

(73) Assignee: HATAYA MFG. CO., LTD., Nagoya (JP)

(21) Appl. No.: 10/408,562

(22) Filed: Apr. 8, 2003

(30) Foreign Application Priority Data
Dec. 2, 2002 (JP) 2002-349969

(51) Int. Cl. H01R 13/44

(52) U.S. Cl. 439/138

(57) ABSTRACT

A cap for exposing or closing the prong openings of an electrical socket body can be mounted to the socket body with reduced number of parts, assembly man-hours and costs. The electrical socket body 1 is provided with guide grooves 7 and the cap 8 is formed with protrusions 12 capable of slidably engaging with the guide grooves 7 such that the cap 8 can be rotatably mounted over the socket body 1, whereby the cap 8 can be rotated to expose or close the prong openings in the socket body 1. Therefore, the cap 8 can be mounted over the socket body 1 without using conventional rivets and washers.

### FIELD OF THE INVENTION

The invention relates to an electrical socket that is provided with a cap for closing or exposing the prong openings in a body of the socket.

### PRIOR ART

Heretofore it has been known to provide a cap for an electrical socket connected to one end of an electrical extension cord for closing or exposing the prong openings in a body of the socket in order to prevent moisture, dirt and other foreign matters from entering the prong openings.

Japanese Patent Application Laid-open No. Hei 6-52926/1994, for example, discloses a cap rotatably mounted on a body of an electrical socket by means of a rivet extending through the body and an associated washer so that rotation of the cap about the rivet exposes or covers the prong openings of the socket body.

However, a problem with the above mentioned mounting of the cap on the electrical body by means of rivet and washer is that it requires a number of parts and assembly man-hours and therefore high costs.

### SUMMARY OF THE INVENTION

In view of the above, it is an object of the invention to provide an electrical socket having a cap capable of exposing or closing the prong openings in a body of the electrical socket, which can reduce the number of parts, assembly man-hours and costs in mounting the cap to the socket body.

To achieve the above object, the present invention provides an electrical socket which is characterized by comprising a socket body having a plurality of prong openings and a cap capable of exposing or closing the prong openings, one of the socket body and the cap being formed with guide grooves, and the other being formed with corresponding protrusions slidably engageable with the guide grooves, such that the cap can be rotatably mounted to the socket body, whereby the cap can be rotated to expose or close the prong openings.

By means of the engagement of the guide grooves formed on one of the socket body and the cap with the corresponding protrusions formed on the other, the cap can be mounted to the socket body in a manner allowing exposing or closing the prong openings without using prior art rivet and washer.

It is desirable that the cap can be limited at a position fully exposing the prong openings when the protrusions encounter one end of each guide groove, and at a position fully closing the prong openings when the protrusions encounter the other end of each guide groove.

Therefore, by means of rotation, the protrusions of the cap can encounter one end of each guide groove allowing the cap to be at a position fully exposing the prong openings, and encounter the other end of each guide groove allowing the cap to be at a position fully closing the prong openings, thereby enabling the cap to easily reach the position fully exposing or closing the prong openings.

### BRIEF DESCRIPTION OF THE DRAWINGS

FIG. 1 is a longitudinal sectional view of an electrical socket in accordance with one embodiment of the present invention.

FIG. 2 is an exploded, perspective view of a body of the socket and caps.

FIG. 3 is a plan view showing a set of prong openings fully exposed.

FIG. 4 is a plan view showing the prong openings of FIG. 3 fully closed.

### DETAILED DESCRIPTION OF THE PREFERRED EMBODIMENT

An embodiment of the present invention will be described below in conjunction with the drawings.

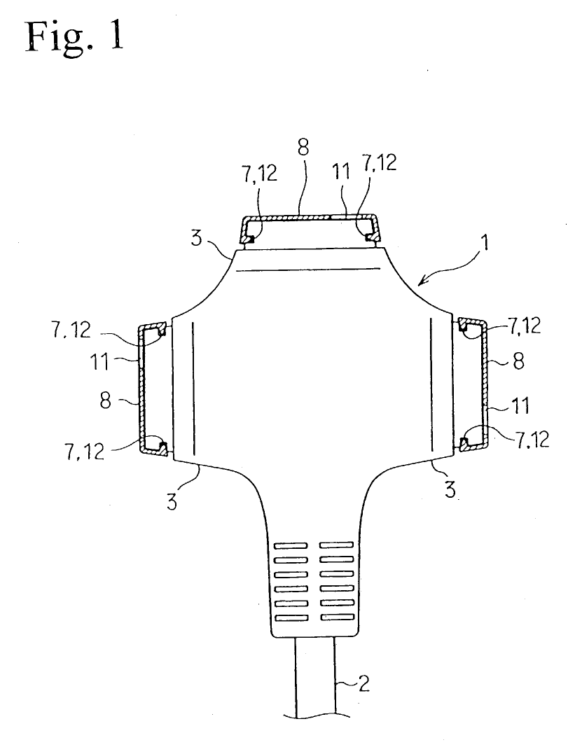

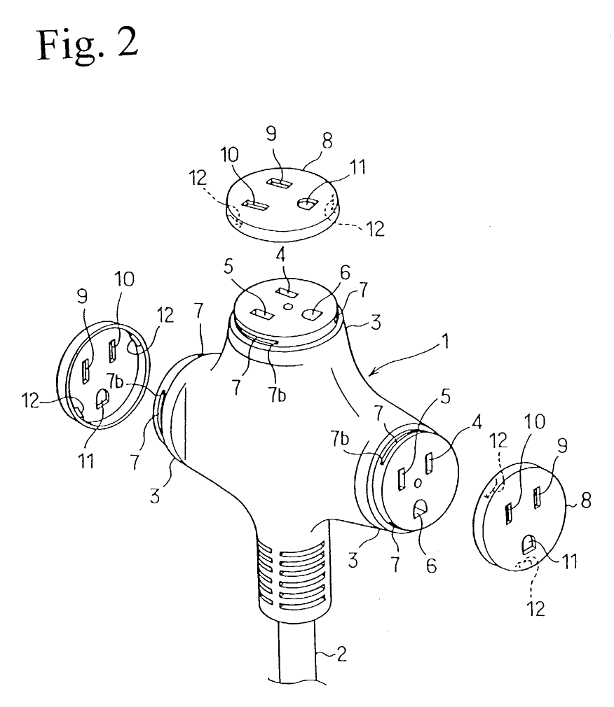

Referring to FIGS. 1 and 2, there is shown an electrical socket body 1 provided at an end of an electric power cord 2. Socket body 1 has a housing formed from electrical insulating material—plastic, and three socket sections 3 projecting in the lengthwise direction of the cord 2 and in the direction transverse to the lengthwise direction of the cord 2.

FIG. 2 illustrates that each of socket sections 3 has a circular front end and prong openings 4, 5 and 6 formed in end face thereof. Prong openings 4 and 5 can be inserted by a pair of prongs of a known electrical plug (not shown), and prong opening 6 can be inserted by a grounding prong of the plug (not shown).

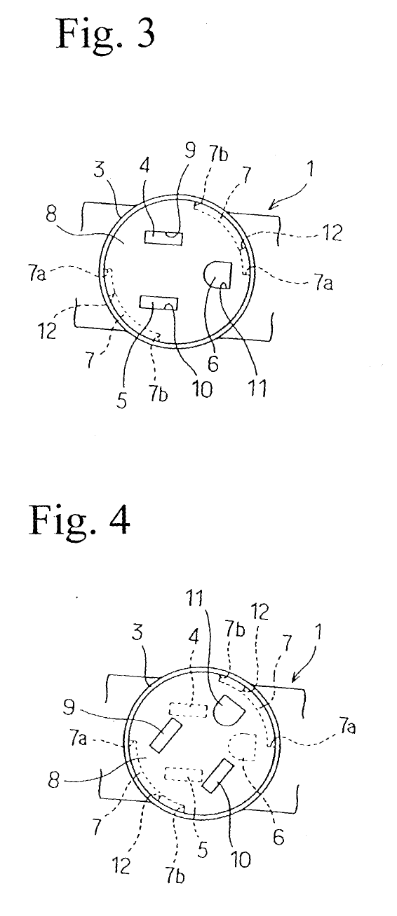

Further, as shown in FIGS. 3 and 4, the front end of socket section 3 is formed with two arcuate guide grooves 7 on its outer periphery. Each of the grooves 7 originates from the end face of socket section 3 and occupies the extended portions of one another.

A short cylindrical cap 8 of plastic is provided in a manner that the frond end of socket section 3 can be covered almost without gap. There are total three caps, corresponding to the number of socket sections 3. Each of the caps 8 has prong apertures 9, 10 and 11 positioned and dimensioned to correspond to the prong openings 4, 5 and 6 of socket sections 3. Prong apertures 9 and 10 can be inserted through by the pair of prongs of the electrical plug, and prong opening 11 can be inserted through by the grounding prong.

Two protrusions 12 are formed on the inner side of the periphery of cap 8. Protrusions 12 correspond to guide grooves 7 and engage with guide groove 7 such that cap 8 can be mounted over the front end of each socket section 3 of socket body 1.

Next, for the above-described socket, protrusions 12 of cap 8 can slide in the grooves 7 in the lengthwise direction thereof once cap 8 is rotated. With protrusions 12 slidably engaged with grooves 7, cap 8 can be rotated over the front end of socket section 3 of socket body 1.

By means of such rotation, cap 8 can be rotated from a position where its prong apertures 9 to 11 align with prong openings 4 to 6 of socket section 3, fully exposing prong openings 4 to 6, as shown in FIG. 3, to a position where its prong apertures 9 to 11 do not align with prong openings 4 to 6 of socket section 3, fully closing prong openings 4 to 6, as shown in FIG. 4, or vice versa. Therefore, prong openings 4 to 6 of socket section 3 can be exposed or closed.

Particularly, according to the construction of the present embodiment, when the protrusions 12 of cap 8 encounter one end 7a of each groove 7, cap 8 is limited at a position fully exposing the prong openings, as shown in FIG. 3, and when the protrusions 12 of cap 8 encounter the other end 7b of each groove 7, cap 8 is limited at a position fully closing the prong openings, as shown in FIG. 4.

In the present embodiment, prong openings 4 to 6 can be exposed or closed through rotation of cap 8 over the front end of socket section 3 of socket body 1. The assembly of cap 8 is carried out by engaging protrusions 12 formed on cap 8 with guide grooves 7 formed in socket body 1, and no conventional rivets and washers are required. This can achieve the effect of reducing the number of parts, assembly man-hours and costs, as compared with prior arts.

Further, according to the present embodiment, cap 8 is rotated to a position where protrusions 12 encounter one end 7a of each guide groove 7, fully exposing the prong openings, or a position where protrusions 12 encounter the other end 7b of each guide groove 7, fully closing the prong openings, thereby enabling the cap to be easily positioned at the position fully exposing or closing the prong openings.

Guide grooves 7 and protrusions 12 can be provided in an opposite manner, that is, guide grooves 7 may be formed in cap 8 while protrusions 12 may be formed on socket body 1.

Moreover, Socket body 1 may have no prong opening 6 but only prong openings 4 and 5. Correspondingly, cap 8 may have no prong aperture 11 but only prong apertures 9 and 10.

Socket body 1 may even have more or less than three sets of prong openings 4 to 6, or particularly, just one set.

Further, socket body 1 may also be applied to a wall socket, instead of being provided at one end of power cord 2.

The present invention is not limited to the above-described and illustrated embodiment. It is to be understood that various modifications may be made without departing from the scope of the present invention. As described above, according to the electrical socket of the present invention, the assembly of the cap capable of exposing or closing the prong openings of the socket body is carried out by means of the engagement of the guide grooves formed in one of the socket body and the cap with the corresponding protrusions formed on the other, therefore, significant efficacy of reducing the number of parts, assembly man-hours and costs can be achieved.

What is claimed is:

1. An electrical socket characterized by comprising a socket body having a plurality of prong openings and a cap capable of exposing or closing the prong openings, one of the socket body and the cap being formed with guide grooves, and the other being formed with corresponding protrusions slidably engageable with the guide grooves, such that the cap can be rotatably mounted to the socket body, whereby the cap can be rotated to expose or close the prong openings.

2. The electrical socket according to claim 1, characterized in that the cap is limited at a position fully exposing the prong openings when the protrusions encounter one end of each of the guide grooves, and at a position fully closing the prong openings when the protrusions encounter the other end of each of the guide grooves.
